(19) United States
(12) Patent Application Publication
(10) Pub. No.: US 2019/0366610 A1
(43) Pub. Date: Dec. 5, 2019

(54) INJECTION MOLDING METHOD, USE OF A SENSOR, AND INJECTION MOLDING MACHINE

(71) Applicant: Zahoransky Automation & Molds GmbH, Freiburg (DE)

(72) Inventors: Michael Schmidt, Teningen (DE); Norbert Gromann, Gundelfingen (DE); Winfried Ebner, Emmendingen (DE)

(73) Assignee: Zahoransky Automation & Molds GmbH, Freiburg (DE)

(21) Appl. No.: 16/422,094

(22) Filed: May 24, 2019

(30) Foreign Application Priority Data
May 29, 2018 (DE) 102018112 856.8

(51) Int. Cl. B29C 45/76; B29C 45/16; B29C 45/78

(52) U.S. Cl. CPC B29C 45/7613; B29C 45/16; B29C 45/78; B29C 2945/7604; B29C 2945/76859; B29C 2945/76454; B29C 2945/76381; B29C 2945/76545; B29C 2945/76688; B29C 2945/76257

(57) ABSTRACT

An injection-molding method is provided in which in a first injection-molding step at least one first material component (17) is injected into a mold cavity (4) of an injection mold (3). The first injection-molding step is terminated when a condition pertaining to a first material volume that has been injected in the first injection-molding step has been met. This condition can be, for example, a minimum filling level which is caused in the mold cavity (4) by a material volume from the at least one first material component (17) that in the first injection-molding step has been injected into the mold cavity (4). When the minimum filling level can be detected or confirmed, for example with the aid of a sensor (10), the first injection-molding step is terminated and a second injection-molding step can optionally be started.

### INCORPORATION BY REFERENCE

The following documents are incorporated herein by reference as if fully set forth: German Patent Application No. 10 2018 112 856.8, filed May 18, 2019.

### BACKGROUND

The invention relates to an injection-molding method and to an injection molding machine, in each case for the production of injection-molded parts that are injected from at least two material components, in particular brush bodies such as toothbrush bodies or face brush bodies.

In the production of injection-molded parts from at least two material components it has to date been known for a substrate injection-molded part from a first material component, which then forms the core of the injection-molded part, to first be produced in a first injection-molding step. The substrate injection-molded part is subsequently transferred to a further injection mold and in the latter is overmolded with the second material component in a second injection-molding step. The transfer of the substrate injection molded part to a further injection mold is comparatively complex and requires time. Furthermore, at least two injection molds have to be made available in the case of this method, which is relatively expensive.

### SUMMARY

It is therefore an object of the invention to provide an injection-molding method and an injection-molding machine of the type mentioned at the outset in which the aforementioned disadvantages can be minimized or even avoided, and which enable an economic production of injection-molded parts.

In order for said object to be achieved, an injection-molding method for producing injection-molded parts, in particular brush bodies, which has one or more features of the of the invention directed toward such an injection-molding method is first provided. In order for said object to be achieved an injection-molding method in which in a first injection-molding step at least one first material component is injected into at least one mold cavity of an injection mold is in particular provided, wherein the first injection-molding step is terminated when a condition pertaining to a material volume that has been injected in the first injection-molding step has been met, and wherein in a second injection-molding step a second material volume from at least one further material component is injected into the same at least one mold cavity.

The aforementioned condition can be, for example, a filling level which is caused in the mold cavity by the material volume from the at least one first material component that has been injected into the mold cavity in the first injection-molding step. The condition can be monitored, for example, by using a control unit of an injection-molding machine and/or by using a sensor.

In this way it is possible for an injection-molded part that is composed of at least two material components to be produced within one mold cavity of an injection mold without opening the injection mold and transferring a substrate injection-molded part to another molding in which the second injection-molding step is performed. All of the injection-molding steps which are provided for the production of the injection-molded part can thus be carried out in one injection mold. In that the first injection-molding step is terminated when the condition pertaining to the first material volume is met, the method can be controlled in such a manner that the at least two material components from which the injection-molded part is formed can be injected at the desired mutual ratio into a common mold cavity.

An expansion and/or an increase and/or a filling level of the first material volume in the mold cavity during the first injection-molding step herein can at least be indirectly monitored. To this end, at least one sensor, for example the sensor already mentioned above, can be used. The afore-mentioned condition can then be met when a minimum expansion, a minimum increase and/or a minimum filling level is detected, or when a minimum expansion, a minimum increase and/or a minimum filling level is detected and a delay period has elapsed.

A material-free residual volume that has remained in the mold cavity after the first injection-molding step, in the second injection-molding step can expediently be filled up with the second material volume. The latter preferably such that after the termination of the second injection-molding step no unfilled volume is still present within the mold cavity, and the material quantity required for the production of the injection-molded part has been completely filled into said mold cavity.

The second injection-molding step can start before the aforementioned condition is met. However, it is particularly expedient when the second injection-molding starts when the condition is met and the first injection-molding step has thus been terminated. In this way, the at least two material components and material volumes can be successively injected into the mold cavity of the injection mold.

The material volume that is injected into the mold cavity in the first injection-molding step can be at least indirectly detected, registered, determined and/or monitored by a sensor. Furthermore, the condition that pertains to the material volume that is injected in the first injection-molding step can be met when the sensor, caused by the material volume, emits a corresponding signal. The condition can also be met only when the sensor emits a corresponding signal and additionally a predefined delay period has elapsed.

At least part of the condition can be met when a sensor signal that is emitted by the sensor corresponds to a threshold signal or trigger signal and/or when a measured value registered by the sensor corresponds to a threshold value or exceeds such a threshold value.

The material volume that in the first injection-molding step has been injected into the mold cavity of the injection mold and/or the expansion of said material volume and/or the increase thereof and/or the filling level thereof can thus be at least indirectly monitored with the aid of the sensor. As soon as it has been established with the aid of the sensor that the first material volume in the mold cavity is sufficient for meeting the condition, the first injection-molding step can be terminated and the injection of the at least one first material component can be suppressed.

It can be advantageous for the sensor to be disposed so as to be spaced apart from a nozzle by way of which material is injected into the mold cavity in the first injection-molding step.

It can be established with the aid of the sensor whether a filling level which is caused by the first material volume in the mold cavity corresponds to a nominal value and thus is sufficient for terminating the first injection-molding step. Depending on requirements, the first injection-molding step can also be terminated only when a delay period has additionally elapsed after reaching or exceeding the threshold value, or after triggering the sensor. In this way, however, further material can still be injected into the mold cavity of the injection mold in the first injection-molding step so as to ensure that sufficient material is incorporated in the mold cavity.

In the case of one variant of the method described above it can be provided that a temperature within the at least one mold cavity is registered by a temperature sensor. The reaching or exceeding of a defined temperature threshold value can be a precondition therefor that the condition is met. The condition for terminating the first injection-molding step can be met, for example, when the registered temperature reaches or exceeds a temperature threshold value. The temperature sensor can be disposed at a specific location in or on the mold cavity and/or so as to be spaced apart from a nozzle by way of which material is injected into the mold cavity in the first injection-molding step. It can be established by way of the temperature sensor whether a material volume that is sufficient for the subsequent processing has been injected into the mold cavity in the first injection-molding step. In the case of one embodiment of the injection-molding method, the condition for terminating the first injection-molding step can be met when the temperature registered by the temperature sensor within the mold cavity reaches or exceeds a temperature threshold value and moreover a defined delay period after reaching or exceeding the temperature threshold value has elapsed. The temperature threshold value can be predefined such that said temperature threshold value is reached or exceeded only when the first material volume from the at least one first and still hot material component contacts the sensor or a measuring probe of the sensor. A conclusion pertaining to a specific filling level and/or an expansion of the first material volume within the mold cavity can thus be drawn by reaching or exceeding the temperature threshold value.

It is also possible for a temperature variation rate within the mold cavity to be registered with the aid of a temperature sensor. The condition can be met, for example, when the registered temperature variation rate reaches and/or exceeds a defined limit value, or when the registered temperature variation rate reaches and/or exceeds a defined limit value and a defined delay period has elapsed.

In particular when a plurality of mold cavities of an injection mold are to be filled in the injection-molding method, it can be expedient when the temperature threshold value and/or the delay period are/is predefined individually for each mold cavity of the injection mold to be filled.

The temperature threshold value which has to be reached or exceeded in order for the condition to be met, can be between a temperature of the injection mold and a processing temperature of the first and/or the further material component. A temperature of the injection mold can be, for example, 100° C., in particular when said injection mold is heated. Processing temperatures of the first and/or the at least one further material component can be beyond 300° C., depending on the material.

In the case of one variant of the method the temperature threshold value can lie between, for example, 5 and 200 Kelvin above an initial temperature which in the case of an empty mold cavity is measurable by a sensor, for example by the aforementioned temperature sensor, within the mold cavity. The temperature threshold value can also be between 40° C. and 180° C., in particular 80° C.

The aforementioned delay period in the case of one embodiment of the injection-molding method can be between 0 and less than/equal to 2 seconds. The delay period enables further material to be injected into the mold cavity when the sensor has been triggered by the material volume that has already been injected into the mold cavity in the first injection-molding step.

In the case of one embodiment of the injection-molding method the second material volume can be injected into the material volume that is situated in the mold cavity and that has been injected into the mold cavity in the first injection-molding step. In the second injection-molding step a core from the second material volume can be generated within the injected first material volume. This is realized in particular in such a manner that the core is predominantly, or with the exception of a region of the injection point of said core, is/will be surrounded in a fully circumferential manner by the first material volume.

The particularity herein lies in that both the core as well as the material volume surrounding the core are injected into one and the same mold cavity without the injection mold being opened in the intervening time. While in the case of the methods previously known from the prior art the material volume is first injected into a mold cavity in which the core is configured, in the case of this embodiment of the method according to the invention the material that at least partially lies on the exterior of the finished injection-molded part can first be injected into the mold cavity. The second material volume is subsequently injected into the first-injected material volume so as to configure the core of the injection-molded part. The injection mold herein does not have to be opened. A transfer of the injection-molded part to a second injection mold is also not required.

Furthermore, the first material volume can at least partially be displaced within the mold cavity by the second material volume that is injected in the second injection-molding step. The mold cavity can be completely filled with material after the termination of the second injection-molding step. The first material volume herein can at least partially be displaced into at least an end region and/or peripheral region of the mold cavity by the second material volume that is injected in the second injection-molding step, so as to fill above all the external regions of the mold cavity with the first material volume. The at least one first material component which can form the first material volume can thus be relocated to the external region of the mold cavity, where said first material component forms an external layer that is later visible to the end-user of the finished injection-molded part.

To this end, it can be expedient when the first material volume is injected into the mold cavity by way of a nozzle which is disposed on an imaginary line between a nozzle for the second material volume and a sensor, for example the sensor already mentioned above. Due to the disposal of the in this instance two nozzles it can be ensured that the first material volume is injected into the mold cavity such that said first material volume makes its way in front of an opening of the nozzle for the second material volume. The second material volume, by way of the nozzle for the second material volume, can then be injected into the first material volume that has already been injected into the mold cavity.

Depending on the design of the mold cavity to be filled, the reverse disposal of the nozzles can also be expedient. It is thus possible for the second material volume to be injected into the mold cavity by way of a nozzle which is disposed on an imaginary line between a nozzle for the first material volume and a sensor, for example the sensor already mentioned above.

The first and/or the second material volume can be injected into the at least one mold cavity by way of a nozzle or by way of nozzles which, when carrying out the method, in the direction of gravity is/are disposed below a sensor, for example the sensor already mentioned above. It can be particularly expedient when a nozzle by way of which the second material volume is injected into the mold cavity, when carrying out the method, in the direction of gravity is disposed below the nozzle by way of which the first material volume is injected into the mold cavity in the first injection-molding step. By virtue of the effect of gravity, the material that has been injected into the mold cavity in the first injection-molding step makes its way with high certainty in front of the outlet of the nozzle by way of which the material is injected into the mold cavity in the second injection-molding step. Material in the second injection-molding step can thus be injected with high certainty into the material volume that has already been previously injected into the mold cavity in the first injection-molding step, so as to generate the afore-described core in the first material volume, for example. Of course, the nozzle by way of which the first material is injected into the mold cavity, when carrying out the method, can also be displaced below the nozzle by way of which the second material volume is injected into the same mold cavity in the second injection-molding step.

It is to be stressed yet again that the at least two material components in the injection-molding method can be injected into the same at least one mold cavity of the injection mold without opening the injection mold.

For example, PET (polyethylene terephthalate), PP (polypropylene), and/or COP can be used as the material for the material component that is injected into the mold cavity in the first injection-molding step. In particular when the at least one further material component in the second injection-molding step is injected into the material volume that has been formed by the at least one first material component, another material and/or a recyclate of the material of the first material component can be used as the material for the at least one further material component.

Material costs can be saved without compromising the quality of the injection-molded part generated by using a recyclate of the material of the first material component. Since the material volume that is injected in the second injection-molding step can be largely or even completely disposed within the first material volume, adverse visual and/or visual effects in the generated injection-molded part on account of the potentially visually sub-standard recyclate are not to be feared to a disturbing extent.

In order for the aforementioned object to be achieved, the use of a sensor on an injection mold which is used for the production of injection-molded parts is furthermore proposed for starting and/or terminating an injection-molding step.

A sensor signal generated by the sensor can be emitted to a control unit, for example of an injection-molding machine, when a condition for terminating and/or starting an injection-molding step is met. The condition can be met when a material volume required for terminating and/or starting an injection-molding step has been injected within a mold cavity of the injection mold. As has already been set forth in detail above, the sensor can be used for checking the condition and for this purpose for detecting and/or monitoring, for example, an increase, an expansion, and/or a minimum filling level of the material volume that has been injected into the mold cavity in the first injection-molding step.

In order for the object to be achieved, an injection-molding machine for producing injection-molded parts, in particular brush bodies, which has one or more features of the invention directed toward such an injection-molding machine is also provided. In the case of the injection-molding machine according to the invention it is thus in particular provided that the injection-molding machine is specified for carrying out the method described in detail above.

To this end, the injection-molding machine can have an injection mold having at least one mold cavity and at least one nozzle that is assigned to the mold cavity. The mold cavity herein can be configured in such a manner that said mold cavity defines a final shape of the injection-molded part to be produced. Injection-molding material can be incorporated in the mold cavity by way of the at least one nozzle that is assigned to the mold cavity. The at least one nozzle can be a hot runner nozzle. The injection mold can be referred to as an injection-molding tool and can be heatable, or heated, in the operation of the injection-molding machine. It is thus possible for the injection mold to be heated to a temperature, which can also be referred to as the tool temperature, of 100° C., for example.

In order for the afore-described method to be carried out, it can be expedient for the injection-molding machine to have at least one sensor. The sensor can be specified for at least indirectly detecting, registering, determining and/or measuring a material volume that has been injected into at least one mold cavity of the injection mold. The sensor can specifically be specified for detecting, registering, determining and/or measuring an increase, an expansion and/or a filling level of the material volume that has been injected into the at least one mold cavity in the first injection-molding step.

The injection-molding machine can have a control unit. The aforementioned at least one sensor can be connected to the control unit by way of a sensor connection. The control unit can be specified, in particular programmed, for opening and/or closing the at least one nozzle that is assigned to the mold cavity as a function of a sensor signal that is emitted by the at least one sensor.

In this way, the first injection-molding step that has been described in detail above can be terminated by the control unit when it has been established with the aid of the sensor that sufficient material volume has been injected into the mold cavity in the first injection-molding step, thus the afore-described condition pertaining to the material volume that has been injected in the first injection-molding step has been met.

Depending on the type of sensor, it can be expedient for the at least one sensor to be disposed at a defined spacing from the at least one nozzle of the mold cavity. In this way, it can be ensured that the at least one sensor is not triggered immediately after the beginning of the first injection-molding step, such that a sufficiently large material volume can be incorporated in the mold cavity in the first injection-molding step.

When the injection-molding machine has an injection mold in which a plurality of mold cavities for producing injection-molded parts are configured, it can be expedient for in each case one sensor to be assigned to each mold cavity of the injection mold.

The at least one sensor of the injection-molding machine can be a temperature sensor. A temperature increase in the interior of the at least one mold cavity can be established with the aid of the temperature sensor, said temperature increase being caused by the injection of the at least one material component in the first injection-molding step. In particular when the temperature sensor is disposed at a certain distance from the nozzle by way of which the at least one first material component is injected into the mold cavity in the first injection-molding step, the temperature sensor will be able to establish a corresponding temperature increase only once the material volume that has been injected into the mold cavity in the first injection-molding step has achieved a corresponding expansion and makes its way into the registering range of the sensor.

The first injection-molding step can then be terminated by the control unit when the temperature value registered by the temperature sensor reaches or exceeds a defined temperature threshold value that has been stored in the control unit, for example. The control unit can optionally terminate the first injection-molding step also only when a previously defined delay period which, for example as has been already mentioned above, can be between 0 and 2 seconds, has additionally elapsed after reaching or exceeding the temperature threshold value.

The at least one sensor can furthermore have a measuring probe which at least partially is disposed in or on the mold cavity assigned thereto. The measuring probe can be disposed so as to be flush in a wall of the mold cavity, thus not to protrude into the mold cavity. It is however also possible for the measuring probe to protrude beyond a wall of the mold cavity into the mold cavity, for example to protrude by between 0 and 1 mm into the mold cavity. When the material volume that has been incorporated in the mold cavity in the first injection-molding step reaches the measuring probe, said material volume can surround said measuring probe such that measuring, in particular temperature measuring, can be performed in a particularly swift and reliable manner. The at least one sensor herein can be disposed in or on the mold cavity in such a manner that a defined minimum filling level has to be reached within the mold cavity by the first material volume before the sensor is triggered by the material volume that has been injected in the first injection-molding step.

Each nozzle of the injection-molding machine can be assigned an actuator by way of which the respective nozzle can be opened and/or closed. Each actuator, by way of a control connection, can be connected to the control unit of the injection-molding machine. As soon as the control unit establishes that the condition pertaining to the material volume that has been injected into the mold cavity in the first injection-molding step has been met, said control unit can emit a corresponding control signal to the actuator in order for the nozzle by way of which material has been injected into the mold cavity in the first injection-molding step to be closed. The control unit can thus terminate the first injection-molding step.

As soon as the control unit establishes that the condition is met, said control unit can also start the second injection-molding step. To this end, the control unit can emit a corresponding control signal to an actuator which then opens a nozzle by way of which at least one further material component is to be injected into the mold cavity in the second injection-molding step.

The actuator or actuators of the injection-molding machine can in each case comprise a pneumatic cylinder and/or a pneumatic, mechanical, electric, magnetic and/or servo-electric drive.

Each mold cavity of the injection mold of the injection-molding machine can in each case be assigned two nozzles. One of the two injection-molding steps can in each case be carried out, and material can be injected into the mold cavity, by way of each of the two nozzles. The two nozzles in the use position of the injection-molding machine can be disposed so as to be mutually offset in the direction of gravity. In this way, it is possible for the at least one first material component to first be injected into the mold cavity by way of the nozzle that is provided for the first injection-molding step. The material volume that has been injected in the first injection-molding step herein can make its way in front of the nozzle by way of which at least one further material component is injected into the mold cavity in the second injection-molding step. In this way, a core of the injection-molded part can be generated in the second injection-molding step.

The injection-molding machine can furthermore have a duct system which is provided and conceived for the feeding of at least two material components. The duct system can open into the mold cavity by way of at least one nozzle. However, it is also possible for the duct system to open into two nozzles and for in each case one of the at least two material components to be injected by way of each of the two nozzles into the mold cavity for the production of the injection-molded part. Only one mold cavity into which a single duct system opens, by way of which the material components are injected into the mold cavity in two injection-molding steps, is now required for producing the injection-molded part that is composed of at least two material components. The two injection-molding steps herein can be carried out without opening the injection mold of the injection-molding machine in the intervening time. The duct system may be a hot runner duct system.

### BRIEF DESCRIPTION OF THE DRAWINGS

The invention will now be described in more detail with respect to an exemplary embodiment, but is not limited to said exemplary embodiment. Further exemplary embodiments are derived by combining the features of individual or a plurality of claims with one another and/or by combining individual or a plurality of features of the exemplary embodiment. In the figures, in part in a very schematic illustration:

FIG. 1: shows a very schematic side view of an injection-molding machine having an injection mold which comprises two mold halves and in which a plurality of mold cavities are configured, as well as having a control unit on account of which the injection-molding machine is specified for carrying out the injection-molding method that has been described in detail and is claimed in the claims;

FIG. 2: shows a sectional side view of the injection mold illustrated in FIG. 1, after the termination of the first injection-molding step;

FIG. 3: shows the detail marked by the circle K in FIG. 2, in an enlarged illustration; and

FIG. 4: shows the injection mold illustrated in FIGS. 1 to 3, at the end of the second injection-molding step.

### DETAILED DESCRIPTION

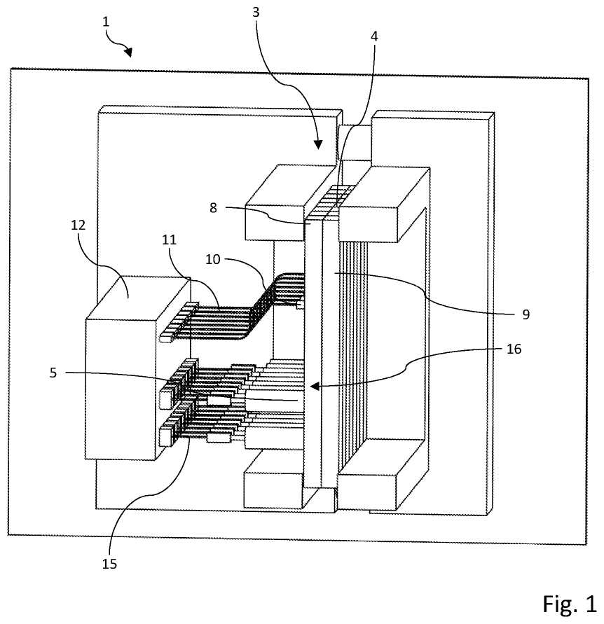

FIG. 1 shows an injection-molding machine which as an entity is identified by the reference sign 1. The injection-molding machine 1 is used for producing injection-molded parts 2. The injection-molded parts 2 which can be produced on the injection-molding machine 1 that is illustrated at least in fragments in the figures are brush bodies 2, specifically toothbrush bodies.

The injection-molding machine 1 has an injection mold 3 in which a total of eight mold cavities 4 are configured. Each mold cavity 4 is in each case assigned two nozzles 5 and 6 by way of which at least two material components 17 and 18 can be injected into the mold cavities 4 in two injection-molding steps, so as to injection-mold a toothbrush body 2 in said mold cavity 4.

Each of the mold cavities 4 is composed of two molding cavities 7 of which one is configured in a nozzle-side mold half 8 and a second is configured in an ejector-side mold half 9.

The nozzles 5 and 6 of the injection-molding machine 1 are in each case configured as hot runner nozzles. The injection-molding machine 1 has a control unit 12 and in each case one sensor 10 for each mold cavity 4. Each sensor 10 is connected to the control unit 12 of the injection-molding machine 1 by way of a sensor connection 11. Each of the sensors 10 is specified for at least indirectly detecting, registering, determining and/or measuring a material volume that is injected into the mold cavity 4 of the injection mold 3 that is assigned to said sensor 10. On account thereof, an expansion and/or a filling level of the material volume that has been injected into the respective mold cavity 4 in the first injection-molding step can be at least indirectly detected and/or determined with the aid of the sensors 10.

The control unit 12 in turn is specified for opening and/or else closing the nozzles 5, 6 assigned to the mold cavities 4 as a function of sensor signals which are emitted by the sensors 10. The sensors 10 within sensor receptacles 10a are disposed at a defined spacing from the nozzles 5, 6. The sensor receptacles 10a in the case of the exemplary embodiment shown in the figures are configured in the nozzle-side mold half 8.

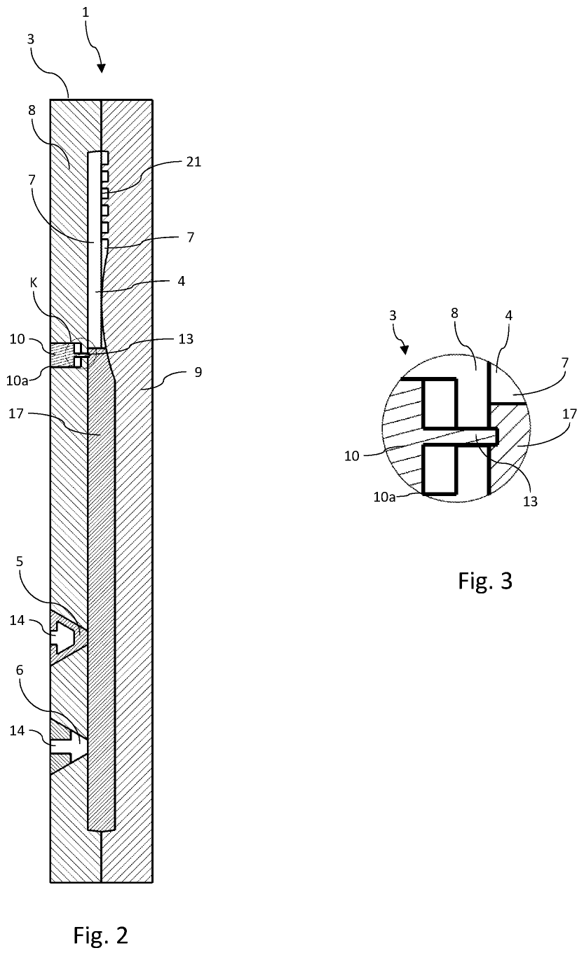

In the case of the exemplary embodiment of the injection-molding machine 1 illustrated in the figures the sensors 10 are temperature sensors. Each of the sensors 10 has a measuring probe 13 which is at least partially disposed in or on the mold cavity 4 assigned to said sensor 10. According to the sectional illustrations of the injection mold 3, the measuring probes 13 are disposed in a wall 14 of the mold cavity 4 thereof in such a manner that said measuring probes 13 protrude beyond the wall 14 of the mold cavity into the mold cavity 4. In the case of the exemplary embodiment of the injection mold 3 shown in FIGS. 2 to 4 the measuring probes 13 protrude into the mold cavity 4 assigned thereto by approximately 1 millimeter.

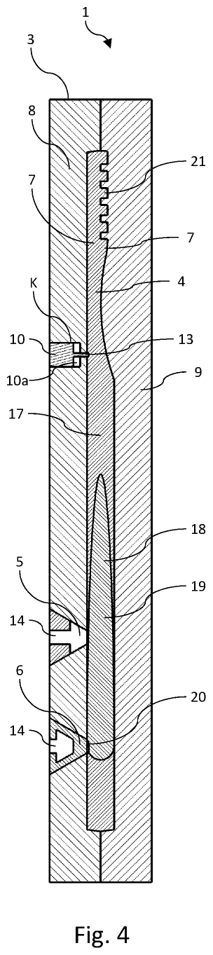

Each nozzle 5, 6 of the injection-molding machine 1 is in each case moreover assigned one actuator 14. Each of the actuators 14 serves for opening and/or closing the nozzle 5, 6 assigned thereto. Each actuator 14, by way of a control connection 15, is connected to the control unit 12 of the injection-molding machine 1. The two nozzles 5, 6, by way of which the at least two material components are injected into the mold cavity 4 which is illustrated in FIGS. 2 and 4, in the use position of the injection-molding machine 1 in the direction of gravity are disposed below the sensor 10.

In particular FIGS. 2 and 4 highlight that the two nozzles 5 and 6 in the use position of the injection-molding machine 1 are disposed so as to be mutually offset in the direction of gravity. The nozzle 6 by way of which the second material component 18 is injected into the mold cavity 4 in a second injection-molding step after the first material component 17 is disposed below the nozzle 5 by way of which the first material component 17 is injected in the first injection-molding step.

In order for the two material components 17 and 18 to be able to be injected into one and the same mold cavity 4 of the injection mold 3, the injection-molding machine 1 is equipped with a corresponding duct system 16 for feeding the two material components 17 and 18. Said duct system 16 by way of the nozzles 5 and 6 opens into the mold cavities 4 of the injection mold 3. The duct system 16 can in particular be a so-called hot runner duct system.

The injection-molding method described hereunder for producing injection-molded parts 2, here specifically for producing brush bodies 2, can be carried out on the injection-molding machine 1 described above.

It is provided herein that in a first injection-molding step at least one first material component 17 is injected into the mold cavities 4 of the injection mold 3. The material volume that is injected in the first injection-molding step herein is at least indirectly monitored. The first injection-molding step is terminated when a condition pertaining to the first material volume that has been injected in the first injection-molding step has been met. In a second injection-molding step a second material volume from at least one further material component 18 can then be injected into the same mold cavities 4.

In the case of one embodiment of the method the second injection-molding step is started only when the aforementioned condition is met. The second injection-molding step can also be started in a delayed manner, after a defined delay period. A wall thickness of the first material component 17 around the second material component 18 which can form a core 19 of the injection-molded part 2 can thus be determined or predefined. A comparatively long delay period results in a comparatively long cooling time and can result in a greater wall thickness of the first material component 17 around the core 19. In principle, however, it is also conceivable for the second injection-molding step to be started already before the condition is met. Meeting the aforementioned condition thus represents at least one criterion for terminating the first injection-molding step.

The material volume that is injected into the respective mold cavity 4 in the first injection-molding step can be at least indirectly detected, registered, determined and/or monitored by way of the sensor 10 already mentioned above. The aforementioned condition, when using a sensor 10 of this type, can be met when the sensor 10 emits a corresponding signal which can be triggered by the material volume that has been injected into the mold cavity 4 in the first injection-molding step.

The condition can in particular be met when a sensor signal that is emitted by the sensor 10 corresponds to a threshold signal or exceeds such a threshold signal. The condition can also be met only when a measured value registered by the sensor 10 corresponds to a threshold value or exceeds such a threshold value. The control unit 12 already mentioned can be specified or programmed in a corresponding manner.

In the case of the injection-molding machine 1 illustrated in the figures a temperature within the mold cavities 4 of the injection mold 3 can be registered and monitored by the sensors 10 of said injection-molding machine 1. This is because the sensor 10 in the present exemplary embodiment of the injection-molding machine 1 is configured as a temperature sensor 10. The condition for terminating the first injection-molding step herein is met when the temperature registered by the sensor 10 reaches or exceeds a defined temperature threshold value and moreover a defined delay period after reaching or exceeding the temperature threshold value has elapsed. The monitoring of the condition and the triggering or terminating of the injection-molding steps can be performed with the aid of the control unit 12 of the injection-molding machine 1. The temperature increase required for terminating the first injection-molding step is then registered by the sensors 10 when the material volume that is injected into the respective mold cavity 4 in the first injection-molding step has reached the filling level illustrated in FIG. 2, or the extent illustrated therein, respectively.

An expansion, an increase and/or a filling level of the first material volume in the mold cavities 4 during the first injection-molding step can thus be at least indirectly monitored with the aid of the sensors 10. The aforementioned condition in one operating mode of the injection-molding machine 1 is met when a minimum expansion, a minimum increase and/or a minimum filling level of the material volume that has been injected in the first injection-molding step is detected within the mold cavities 4 and additionally a delay period has elapsed. The extent resulting therefrom, or the filling level resulting therefrom, respectively, which the first material volume herein occupies within the mold cavity 4 is illustrated in FIG. 2.

On account of the control unit 12 of the injection-molding machine 1, the latter is specified for predefining individually a temperature threshold value and/or a delay period for each mold cavity 4 of the injection mold 3 of said injection-molding machine 1 to be filled. The temperature threshold value can lie between 5 and 200 Kelvin above an initial temperature which in the case of an empty mold cavity 4, thus in the case of a non-filled injection mold 3, is measurable by the sensor 10. The temperature threshold value can thus be between, for example, 40° C. and 180° C., in particular 80° C. However, it is preferable for the temperature threshold value to lie between a temperature of the injection mold 3 and the processing temperature of the first and/or the second material component 17, 18. In particular when the injection mold 3 is heated, the latter in the use of the injection-molding machine 1 can have a temperature of, for example, 100° C. The processing temperature depends on the choice of material components 17 and 18, and can be above 300° C. Depending on the values predefined by said parameters, the temperature threshold value can then lie between 100° C. and above 300° C.

The delay period which after reaching or exceeding the temperature threshold value is yet to time out before the first injection-molding step is terminated, can be between 0 and less than/equal to 2 seconds.

The second material volume according to FIG. 4 is injected directly into the first material volume from the first material component 17 that is already situated in the respective mold cavity 4. A core 19 from the second material volume of the second material component 18 herein is generated within the previously injected material volume in the second injection-molding step. This is performed in such a manner that the core 19 is predominantly, or with the exception of a region of the injection point 20 of said core (19), is surrounded in a fully circumferential manner by the first material volume that is formed from the first material component 17.

The first material volume herein is at least partially displaced within the mold cavity 4 by the second material volume that is injected in the second injection-molding step. The displacement of the first material volume from the first material component 17 herein is performed in an end region and/or peripheral region 21 of the respective mold cavity 4. The result of this procedure becomes particularly evident by a comparison of the two FIGS. 2 and 4.

FIG. 2 shows the situation which arises after the termination of the first injection-molding step. It can be seen here that the mold cavity 4 is filled with a first material volume from the first material component 17. This being in such a form that the first material component 17 rises in the mold cavity 4 to the extent that said first material component 17 surrounds the measuring probe 13 of the sensor 10. A temperature increase can already be established by the sensor 10 and the measuring probe 13 thereof during the increase of the material volume from the first material component 17 within the mold cavity 4 during the first injection-molding step. When the first material volume from the first material component 17 surrounds the measuring probe 13 of the sensor 10 as is illustrated in FIGS. 2 and 3, the heat of the still hot first material component 17 is transmitted to the measuring probe 13. The sensor 10 can thus register a corresponding temperature increase and emit a corresponding signal to the control unit 12 by way of the sensor connection 11. As soon as the temperature value registered by the sensor 10 exceeds a predefined temperature threshold value, the control unit 12 by way of the control connection 15 emits a corresponding control signal to the actuator 14 in order for the nozzle 5 by way of which the first material component 17 has been injected into the mold cavity 4 to be closed. On account thereof the first injection-molding step is terminated.

A corresponding control signal by way of a sensor connection 11 is simultaneously transmitted to the actuator 14 which is connected to the nozzle 6 by way of which the second material component 18 is injected into the mold cavity 4. As soon as said actuator 14 receives the corresponding control signal, said actuator 14 opens the nozzle 6 such that the second material component 18 can flow into the mold cavity 4 so as to fill up the as yet unfilled residual volume of the mold cavity.

The first material volume from the first material component 17 is injected into the mold cavity 4 by way of the nozzle 5. The nozzle 5 lies on an imaginary line between the nozzle 6 for the second material volume, which is injected into the mold cavity 4 in the second injection-molding step, and the sensor 10 that has already been mentioned above.

FIG. 2 highlights that the complete lower region of the mold cavity 4 is filled with the first component 17 in the first injection-molding step. The first material component 17 and the first material volume formed by the latter herein also make their way in front of an outlet of the nozzle 6 by way of which the second material component 18 is injected into the mold cavity 4 in the second injection-molding step. As has already been explained above, both nozzles 5 and 6, when carrying out the method, in the direction of gravity are disposed below the sensor 10. Both material components 17, 18 are injected into the same mold cavity 4 of the injection mold 3. The first material component 17 can be composed of, for example, PET, PP, and/or COP. Another material than that in the first injection-molding step can be used as the material for the at least one further material component 18 in the second injection-molding step. It is thus possible, for example, for a recyclate of the material of the first material component 17 to be used.

In the case of the injection-molding machine 1 it is thus provided that at least one sensor 10 on the injection mold 3 of the injection-molding machine is used for starting and/or terminating at least one injection-molding step.

The invention relates to improvements in the technical field of the production of injection-molded parts 2. To this end, an injection-molding method in which in a first injection-molding step at least the first material component 17 is injected into the mold cavity 4 of the injection mold 3 is proposed. The first injection-molding step is terminated when a condition pertaining to a first material volume that has been injected in the first injection-molding step has been met. Said condition can be, for example, a minimum filling level which is caused in the mold cavity 4 by a material volume from the at least one first material component 17 that in the first injection-molding step has been injected into the mold cavity 4. When the minimum filling level can be detected or confirmed, for example with the aid of a sensor 10, the first injection-molding step can be terminated and a second injection-molding step can optionally be started.

### LIST OF REFERENCE SIGNS

1 Injection-molding machine
2 Injection-molded parts/brush bodies/toothbrush bodies
3 Injection mold
4 Mold cavity
5 Nozzle for the first material component
6 Nozzle for the second material component
7 Molding cavity
8 Nozzle-side mold half
9 Ejector-side mold half
10 Sensor
10a Sensor receptacle in 8
11 Sensor connection
12 Control unit
13 Measuring probe
14 Actuator
15 Control connection
16 Duct system
17 First material component
18 Second material component
19 Core
20 Injection point
21 End region/peripheral region of 4

1. An injection-molding method for producing injection-molded parts (2), the method comprising:
in a first injection-molding step, injecting at least one first material component (17) into a mold cavity (4) of an injection mold (3);
terminating the first injection-molding step when a condition pertaining to a first material volume that has been injected in the first injection-molding step has been met; and
in a second injection-molding step, injecting a second material volume from at least one further material component (18) into the mold cavity (4).

2. The injection-molding method as claimed in claim 1, further comprising at least indirectly monitoring at least one of an expansion, an increase, or a filling level of the first material volume in the mold cavity (4) during the first injection-molding step using a sensor (10), and determining that the condition is met when at least one of a minimum expansion, a minimum increase, or a minimum filling level is detected, or when at least one of a minimum expansion, a minimum increase, or a minimum filling level is detected and a delay period has elapsed.

3. The injection-molding method as claimed in claim 2, wherein a material-free residual volume that remains in the mold cavity (4) after the first injection-molding step, is filled up with the second material volume in the second injection-molding step, or the second injection-molding step starts before or when the condition is met.

4. The injection-molding method as claimed in claim 1, wherein the material volume that is injected into the mold cavity (4) in the first injection-molding step is at least one of at least indirectly detected, registered, determined, or monitored by a sensor (10), and the sensor (10) is disposed so as to be spaced apart from a nozzle (5) for the first injection-molding step, or wherein the condition is met when the sensor (10) emits a corresponding signal based on the first material volume, or when the sensor (10) emits a corresponding signal based on the first material volume and additionally a predefined delay period has elapsed.

5. The injection-molding method as claimed in claim 1, wherein a temperature within the at least one mold cavity (4) is registered by a temperature sensor (10), and the condition is met when a registered temperature reaches or exceeds a temperature threshold value, or when the registered temperature within the at least one mold cavity reaches or exceeds the temperature threshold value and a defined delay period after reaching or exceeding the temperature threshold value has elapsed.

6. The injection-molding method as claimed in claim 5, wherein at least one of the temperature threshold value or the delay period is predefined individually for each said mold cavity (4) of the injection mold (3) to be filled.

7. The injection-molding method as claimed in claim 5, wherein at least one of: the temperature threshold value lies between a temperature of the injection mold (3) and a processing temperature of at least one of the first or the further material component (17, 18); the temperature threshold value lies between 5 and 200 Kelvin above an initial temperature which for an empty mold cavity (4) is measurable by the temperature sensor (10); or the temperature threshold value is between 40° C. and 180° C., in particular 80° C.

8. The injection-molding method as claimed in claim 5, wherein the delay period is between 0 and less than or equal to 2 seconds.

9. The injection-molding method as claimed in claim 1, wherein at least one of: the second material volume is injected into the first material volume that is situated in the mold cavity (4); or the second injection-molding step generates a core (19) from the second material volume within the injected first material volume, with the core (19) predominantly surrounded in a fully circumferential manner by the first material volume.

10. The injection-molding method as claimed in claim 1, wherein the first material volume within the mold cavity (4) is at least partially displaced by the second material volume that is injected in the second injection-molding step at least in one of an end region or a peripheral region (21) of the mold cavity (4).

11. The injection-molding method as claimed in claim 2, wherein the first material volume (17) is injected into the mold cavity (4) by a nozzle (5) disposed on an imaginary line between a nozzle (6) for the second material volume and the sensor (10), or the second material volume is injected into the mold cavity (4) by a nozzle (6) which is disposed on an imaginary line between a nozzle (5) for the first material volume and the sensor (10).

12. The injection-molding method as claimed in claim 2, wherein at least one of the first material volume or the second material volume is injected into the at least one mold cavity (4) by way of at least one nozzle (5, 6) which when carrying out the method is disposed below the sensor (10) in a direction of gravity.

13. The injection-molding method as claimed in claim 1, wherein at least the first and second material components (17, 18) are injected into the same at least one mold cavity (4) of the injection mold (2) without opening the injection mold.

14. The injection-molding method as claimed in claim 1, wherein in the first injection-molding step at least one of PET, PP, or COP is used as the material for the first material component (17), and in the second injection-molding step at least one of another material than that in the first injection-molding step or a recyclate of the material of the first material component (17) is used as the material for the at least one further material component (18).

15. An injection mold, comprising a mold (3) and a sensor (10) adapted for at least one of starting or terminating an injection-molding step.

16. An injection-molding machine (1) for producing injection-molded parts (2), configured for carrying out the injection-molding method as claimed in claim 1.

17. The injection-molding machine (1) of claim 16, further comprising an injection mold (3) having at least one mold cavity (4), at least one nozzle (5, 6) assigned to the mold cavity (4), and a heater for the injection mold.

18. The injection-molding machine (1) as claimed in claim 17, further comprising at least one sensor (10), a control unit (12), and a sensor connection (11) that connect the at least one sensor (10) to the control unit (12), the at least one sensor (10) is configured for at least one of at least indirectly detecting, registering, determining, or measuring a material volume injected in the at least one mold cavity (4) of the injection mold, within the mold cavity (4).

19. The injection-molding machine (1) as claimed in claim 18, wherein the control unit (12) is configured for at least one of opening or closing the at least one nozzle (5, 6) that is assigned to the mold cavity (4) as a function of a sensor signal that is emitted by the at least one sensor (10).

20. The injection-molding machine (1) as claimed in claim 18, wherein the at least one sensor (10) is disposed at a defined spacing from the at least one nozzle (5, 6) of the mold cavity (4), or the at least one sensor comprises a plurality of sensors, and each said mold cavity (4) of the injection mold (3) is in each case assigned one of the plurality of sensors (10).

21. The injection-molding machine (1) as claimed in claim 18, wherein the at least one sensor (10) is a temperature sensor.

22. The injection-molding machine (1) as claimed in claim 18, wherein the at least one sensor (10) has a measuring probe (13) which at least partially is disposed in or on the mold cavity (4) assigned thereto, and the measuring probe (13) is disposed so as to be flush in a wall of the mold cavity or protrudes beyond the wall (14) of the mold cavity (4) into the mold cavity (4) up to 1 mm.

23. The injection-molding machine (1) as claimed in claim 18, wherein each said nozzle (5, 6) of the injection-molding machine (1) is assigned an actuator (14) for at least one of opening or closing the nozzle (5, 6), and the actuator (14) is connected to the control unit (12) by a control connection (15).

24. The injection-molding machine (1) as claimed in claim 23, wherein the at least one nozzle (5, 6) of the at least one mold cavity (4) in a use position of the injection-molding machine (1) is disposed below the sensor (10) in a direction of gravity.

25. The injection-molding machine (1) as claimed in claim 23, wherein the at least one nozzle comprises a plurality of nozzles, and each said mold cavity (4) is in each case assigned two of the nozzles (5, 6) which in a use position of the injection-molding machine (1) are disposed mutually offset in a direction of gravity.

26. The injection-molding machine (1) as claimed in claim 18, further comprising a duct system (16) for the feeding of at least the first and second material components, said duct system (16) opening via the at least one nozzle (5, 6) into the at least one mold cavity (4).
